(19) United States
(12) Patent Application Publication
(10) Pub. No.: US 2022/0207460 A1
(43) Pub. Date: Jun. 30, 2022

(54) METHOD AND APPARATUS FOR DISPATCHING TO A GEO-LOCATION

(71) Applicant: BloomBridge, LLC, Brandon, MS (US)

(72) Inventors: Huey Jiun Ngo, Brandon, MS (US); Kristen Harpole Allen, Brandon, MS (US); Justin K. Johnson, Woodstock, GA (US)

(21) Appl. No.: 17/565,042

(22) Filed: Dec. 29, 2021

Related U.S. Application Data
(60) Provisional application No. 63/131,649, filed on Dec. 29, 2020.

(51) Int. Cl. G06Q 10/08; G06V 30/18; G06V 30/142; G06F 3/14; G06V 30/19; G06F 3/0483

(52) U.S. Cl. CPC G06Q 10/083; G06V 30/18; G06F 3/0483; G06F 3/14; G06V 30/19; G06V 30/142

(57) ABSTRACT

An approach for receiving a request for dispatching to a physical site for delivery of an item is disclosed, wherein the physical site includes a personal identifier. The approach involves determining location information for the physical site wherein the location information includes address of a destination area that encompasses the physical site. The approach also involves generating a dispatch message to instruct a dispatcher to travel to the destination area according to the determined location to deliver the item. The approach further involves receiving a geo-tagged image of the physical site as verification of the physical site and the personal identifier. The approach also involves extracting textual information from the geo-tagged image, and determining that the textual information corresponds to the personal identifier. Further, the approach involves initiating update of the location information with geo-location information of the geo-tagged image, and storage of the geo-tagged image and the textual information.

### RELATED APPLICATIONS

This application claims the benefit of the earlier filing date under 35 U. S.C. § 119(e) of U.S. Provisional Patent Application Ser. No. 63/131,649, entitled “METHOD AND APPARATUS FOR DISPATCHING TO A GEO-LOCATION,” filed on Dec. 29, 2020, the contents of which are hereby incorporated herein in their entirety by this reference.

### BACKGROUND

E-commerce continues to experience tremendous growth for in sectors, particularly with respect to consumer goods and services. A consumer can readily order goods and services through their mobile devices or computers for delivery. However, typical delivery of such goods and services have been tied to a physical address (e.g., home address, work address, etc.). Consequently, under this constraint deliveries requiring more granular location points cannot be made.

### SOME EXAMPLE EMBODIMENTS

Therefore, there is a need for an approach that provides more exacting geo-location information for dispatching of delivery items.

According to one embodiment, a method comprises receiving a request for dispatching to a physical site for delivery of an item, wherein the physical site includes a personal identifier. The method further comprises determining location information for the physical site. The method further comprises generating a dispatch message to instruct a dispatcher to travel to a destination area according to the determined location information, wherein the destination area encompasses the physical site. The method further comprises receiving a geo-tagged image of the physical site as verification of the physical site and the personal identifier. The method further comprises extracting textual information from the geo-tagged image, and determining that the textual information corresponds to the personal identifier. The method further comprises initiating update of the location information with geo-location information of the geo-tagged image, and storage of the geo-tagged image and the textual information.

According to another embodiment, a system comprises a memory configured to store computer-executable instructions; and one or more processors configured to execute the instructions to receive a request for dispatching to a physical site for delivery of an item, wherein the physical site includes a personal identifier. The one or more processors are further configured to execute the instructions to determine location information for the physical site, wherein the location information includes address of a destination area that encompasses the physical site. The one or more processors are further configured to generate a dispatch message to instruct a dispatcher to travel to the destination area according to the determined location information to deliver the item; receive a geo-tagged image of the physical site as verification of the physical site and the personal identifier; extract textual information from the geo-tagged image; determine that the textual information corresponds to the personal identifier; and initiate update of the location information with geo-location information of the geo-tagged image, and storage of the geo-tagged image and the textual information.

According to another embodiment, an apparatus comprises at least one processor, and at least one memory including computer program code for one or more computer programs, the at least one memory and the computer program code configured to, with the at least one processor, cause, at least in part, the apparatus to receive a request for dispatching to a physical site for delivery of an item, wherein the physical site includes a personal identifier. The apparatus is also caused to determine location information for the physical site, wherein the location information includes address of a destination area that encompasses the physical site, and to generate a dispatch message to instruct a dispatcher to travel to the destination area according to the determined location information to deliver the item. The apparatus is further caused to receive a geo-tagged image of the physical site as verification of the physical site and the personal identifier, and to extract textual information from the geo-tagged image. The apparatus is also caused to determine that the textual information corresponds to the personal identifier. The apparatus is also caused to initiate update of the location information with geo-location information of the geo-tagged image, and storage of the geo-tagged image and the textual information.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between the service provider and mobile device with actions being performed on both sides.

For various example embodiments, the following is applicable: An apparatus comprising means for performing a method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of geo-location dispatch system, according to one embodiment;

FIG. 2 is a diagram of the components of the geo-location dispatch system of FIG. 1, according to one embodiment;

FIG. 3 is a flowchart of a process for dispatching to a geo-location, according to one embodiment;

FIG. 4 is a diagram of the processes of the components of the geo-location dispatch system, according to various example embodiments;

FIGS. 5A and 5B are diagrams of a graphical user interface (GUI) for specifying a cemetery for flower delivery to a grave site, according to various example embodiments;

FIG. 6 is a diagram of a GUI providing a map of a cemetery, according to various example embodiments;

FIG. 7 is a diagram of a GUI associated with customer orders for delivery according to a geo-location within a cemetery, according to various example embodiments;

FIGS. 8A and 8B are diagrams of a GUI for selection of delivery items to a geo-location within a cemetery, according to various example embodiments;

FIG. 9A-9C are diagrams of a GUI associated with customer orders, according to various example embodiments;

FIGS. 10A and 10B are diagrams of a GUI associated with scheduling and selection of delivery items, according to various example embodiments;

FIGS. 11A-11C are diagrams of a GUI associated with a mobile application utilized by a dispatcher, according to various example embodiments;

FIG. 12 is a diagram of hardware that can be used to implement various example embodiments;

FIG. 13 is a diagram of a chip set that can be used to implement various example embodiments; and

FIG. 14 is a diagram of a mobile terminal (e.g., handset) that can be used to implement various example embodiments.

### DESCRIPTION OF SOME EMBODIMENTS

Examples of a method, apparatus, and computer program for dispatching to a geo-location are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

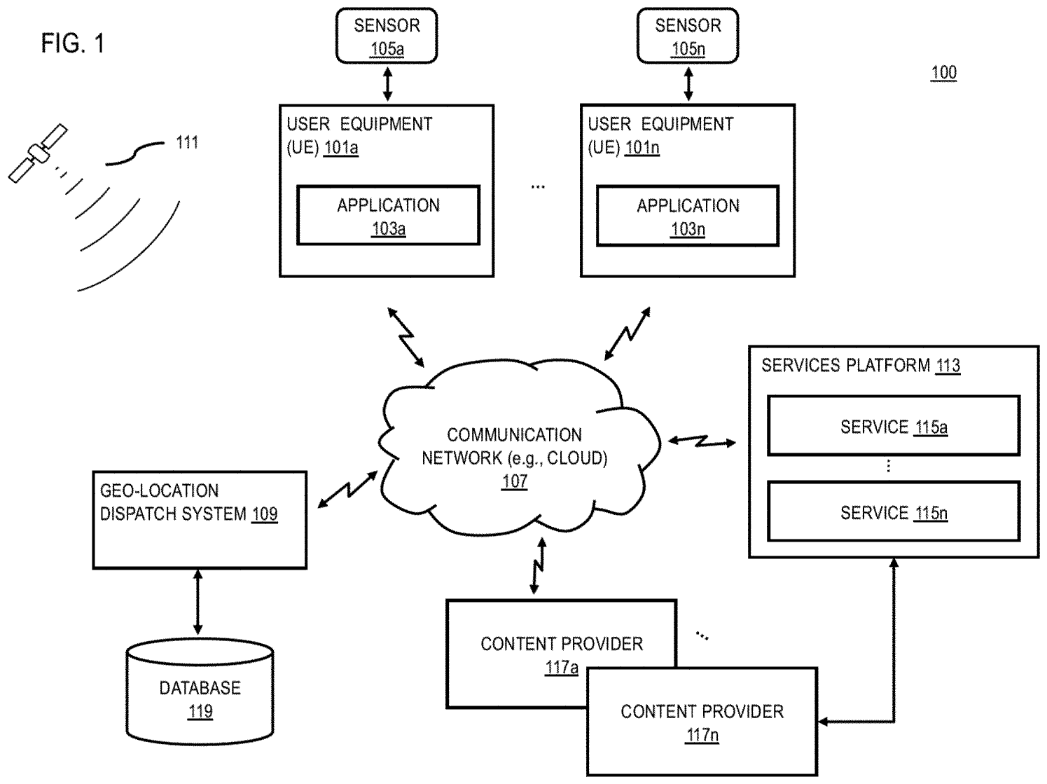

FIG. 1 is a diagram of a geo-location dispatch system, according to one embodiment. Although the uses cases described herein relate to delivery of goods (e.g., flowers, balloons, gifts, etc.) to a physical site (e.g., grave site), it is contemplated that the processes and mechanisms of geo-location dispatch system can be deployed to other goods as well as services (e.g., maintenance, cleaning, etc.). As noted, traditionally, delivery of such goods or services rely on a physical address. For certain facilities or compounds, e.g., cemeteries, an address would not permit the type of granularity of location points to efficiently permit a dispatcher to arrive at a particular physical site (e.g., grave site).

To address the granularity problem, a system 100 of FIG. 1 includes a geo-location dispatch system that introduces the capability to accurately dispatch to a geo-location that is more precise than a physical address. As shown in FIG. 1, the system 100 also comprises user equipment (UE) 101a-101n (collectively referred to as UE 101) that may include or be associated with applications 103a-103n (collectively referred to as applications 103) and sensors 105a-105n (collectively referred to as sensors 105). The sensors 105, in one embodiment, is a camera that captures images and/or video. In one embodiment, the UE 101 has connectivity to the geo-location dispatch system 109 via the communication network 107. The geo-location dispatch system 109 performs one or more functions associated with providing dispatching and delivery functions in conjunction with the UEs 101a-101n.

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, a smartphone, a smartwatch, smart eyewear, or any combination thereof, including the accessories and peripherals of these devices, or any combination thereof. It is also contemplated that the UE 101 can support any type of interface to the user (such as “wearable” circuitry, etc.). In one embodiment, the UE 101 may include Global Positioning System (GPS) receivers to obtain geographic coordinates from satellites 111 for determining current location and time associated with the UE 101; such GPS information can be utilized to geo-tag images captured by the sensors.

The geo-location dispatch system 109 provides a platform to deliver goods and/or services to a geo-location as prescribed, ordered, or requested by an end user/customer through an application resident on an UE 101. In one embodiment, the geo-location need not be associated with a physical address associated.

By way of example, the applications 103 may be any type of application that is executable at UE 101, such as content provisioning services, camera/imaging application, media player applications, social networking applications, calendar applications, and the like. In one embodiment, the applications 103 may assist in conveying sensor information via the communication network 107. In another embodiment, one of the applications 103 at the UE 101 may act as a client for the geo-location dispatch system 109 and perform one or more functions associated with the functions of the geo-location dispatch system 109 by interacting with the geo-location dispatch system 109 over the communication network 107.

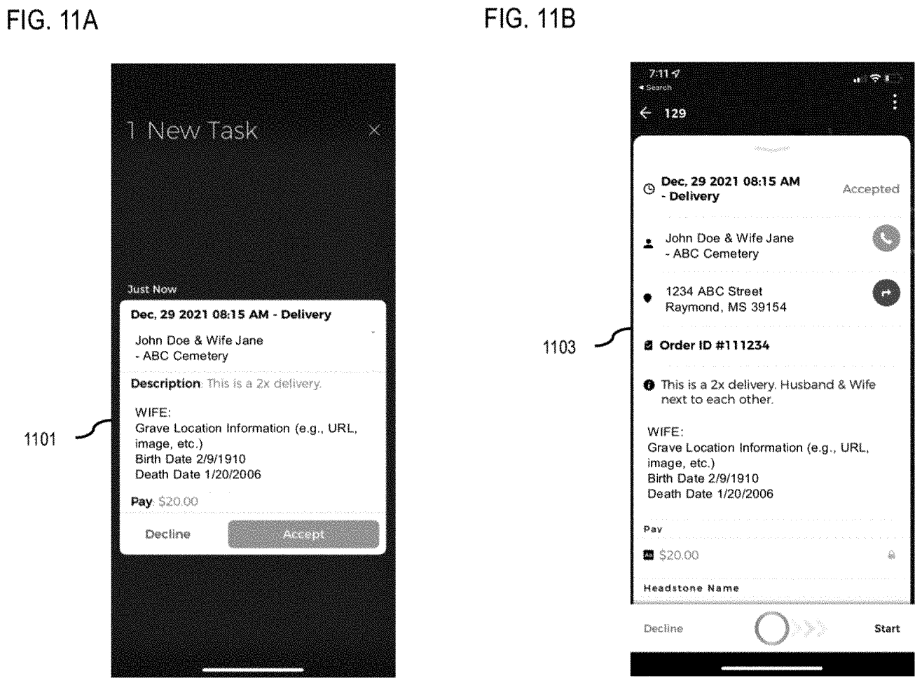

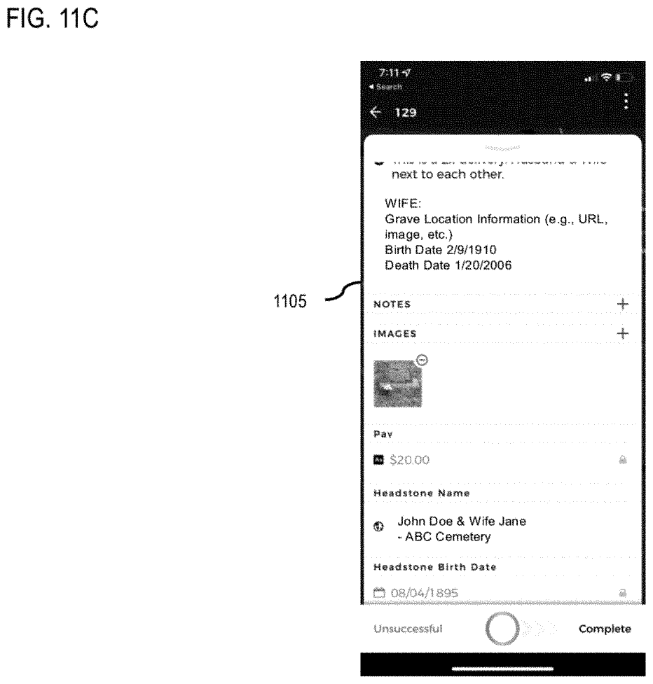

According to one use case of flower delivery to a grave site, the geo-location dispatch system 109 interacts with a user (e.g., consumer) application on UE 101a to dispatch a dispatching agent (e.g., human, drone, etc.); in the case of a human agent, a dispatcher application resident on UE 101n can be instructed to deploy the dispatching agent, e.g., delivery person, to the requested grave site. Such a mobile application, according to one embodiment, is shown in FIGS. 11A-11C. It is contemplated that the geo-location dispatch system 109 can also enable the delivery of services ordered to a geo-located grave site for cleaning and maintenance. While this use case is targeted towards a grave site, the system 109 can be applied to delivery of goods and or services to a geo-location that does not have an associated physical address, such as a tree within a forest or a person traveling about a city.

The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including 5G (5^{th} Generation), 4G, 3G, 2G, Long Term Evolution (LTE), enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the geo-location dispatch system 109 may be a platform with multiple interconnected components. The geo-location dispatch system 109 may include multiple servers, intelligent networking devices, computing devices, components and corresponding software for providing real-time feedback based, at least in part, on analysis of sensor information. In addition, it is noted that the geo-location dispatch system 109 may be integrated or separated from services platform 113. Also, certain functionalities of the system 109 may reside within the UE 101 (e.g., as part of the applications 103).

As shown in FIG. 1, the system 109 can interface a services platform 113, which provides various services, such as notification services, content (e.g., audio, video, images, etc.) provisioning services, application services, storage services, contextual information determination services, social networking services, location-based services, information-based services, etc. In one embodiment, the services platform 113 may interact with the UE 101, the geo-location dispatch system 109 and the content provider 117 to supplement or aid in the processing of the content information.

In the embodiment of FIG. 1, content providers 117a-117n (collectively referred to as content provider 117) may provide content to the UE 101, the geo-location dispatch system 109, and the services 115 of the services platform 113. The content provided may be any type of content, such as image content (e.g., pictures), textual content, audio content, video content, etc. In one embodiment, the content provider 117 may provide content that may supplement the content of the applications 103, the sensors 105, or a combination thereof. In another embodiment, the content provider 117 may also store content associated with the UE 101, the geo-location dispatch system 109, and the services 115 of the services platform 113. In a further embodiment, the content provider 117 may manage access to a central repository of data and offer a consistent, standard interface to data.

Associated with the geo-location dispatch system 109 is database 119. It is contemplated that database 119 can be implemented as a cloud storage system. In one embodiment, the database 119 stores sensor data (e.g., captured images of grave sites with delivered flowers) as well as user/subscriber profile information.

By way of example, UE 101, the geo-location dispatch system 109, the services platform 113, and the content provider 117 communicate with each other and other components of the communication network 107 using well known, new or still developing protocols (e.g., IoT standards and protocols). In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

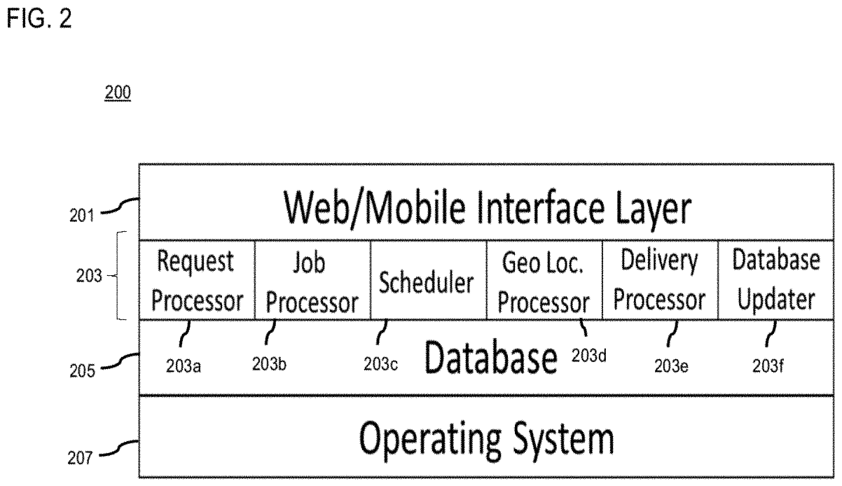

FIG. 2 is a diagram of the components of the geo-location dispatch system of FIG. 1, according to one embodiment. By way of example, the geo-location dispatch system 109 includes one or more components 200 for providing dispatching (e.g., in real-time) to a geo-location. It is contemplated that the functions of these components may be combined in one or more components or performed by other components of equivalent functionality. In this embodiment, the geo-location dispatch system 109 includes the following modules: a web/mobile interface layer 201, a processing layer 203 (which includes a request processor 203a, a job processor 203b, a schedular 203c, a geo-location processor 203d, a delivery processor 203e, a database updater 203f), a database 205, and an operating system 207. In one embodiment, the web and mobile interface layer can be separate remote layers providing user interface interactions with the users.

In one embodiment, the request processor 203a processes new requests that are received. A new request for delivery of a good or service can originate from various scenarios: via the web/mobile interface layer 201, via a subscription process. The web/ mobile interface layer 201 are available to user via the UE 101 and associated applications.

With respect to requests stemming from a subscription, these new requests originate from a scheduled event trigger. For example, a request that was submitted with a subscription for a repeat of this same request at a predetermined interval interacts with the scheduler module 203c to store and configure a scheduled event that will be triggered at the predetermined interval. At the point of the scheduled trigger, a new request will be submitted to the geo-location dispatch system 109 and processed as a new order.

In the use case of a grave site, a flower arrangement for a grave site can be ordered either via a mobile app or web page launched by a UE 101. Such an order represents a new request—e.g., which can be for delivery of flowers or gifts or for maintenance or cleaning). The order can be a single instance whereby the order only includes a single flower arrangement delivered to a grave site one time only. This order can also be a new order with a subscription where a flower arrangement is to be delivered to a grave site once every predetermined interval (e.g., once every 3 months, 6 months, 12 months, on special occasions (e.g., birthdays, anniversaries, holidays, etc.), etc.). This new order can also be in the form of a subscription that was initiated or set previously from a prior order and the predetermined interval has passed, thereby triggering a new order request to be processed.

The geo-location processor 203d is responsible for processing geo-location information as well as resolving non-geo location information into geo-location information. In the event of a set of geo-location information being passed in, the processor 203d processes and stores this information into the database 205 of location information; subsequently, the module passes this set of information on to the job processor 203b. In terms of resolving data that is not strictly geo-location information (i.e., non-geo-location information), the processor 203d initiates a query the database 205 to determine whether there is a corresponding geo-location that can be resolved to. The resolved geo-location information is then passed to the job processor 203b. In the case of the querying of database is unable to determine a corresponding geo-location, the processor 203d can attempt to resolve using external Application Programming Interfaces (APIs) as well as a manual resolution (as explained in detail later). By way of example, geo-location coordinates can be resolved when an order is placed for a flower arrangement to be delivered to a grave site via the web page or mobile application utilizing the services available to the web or mobile applications. Under the scenario in which the services are not able to resolve the geo-location coordinates, the system 109 will attempt to resolve once the database further populated with appropriate geo-location data.

As noted, the job processor 203b can handle jobs/requests for the two scenarios: when geo-location is available, and when geo-location is not available. In the former case, this processor 203d passes the geo-location information to a task/mechanism that identifies the available delivery medium within a configurable geofence radius centered around the specified geo location coordinates. This process may involve querying the database 205 for available delivery medium within the geofence radius. Once the available delivery medium is identified within this geofence range, the job requests are sent out for acceptance by a job dispatch request process, which uses one or more configurable algorithms to request for job dispatch acceptance. Requests can be sent out using, for example, an algorithm that follows the priorities set forth as a value associated with the delivery medium. Such a value can represent various configurable representation of the value such as preferred delivery medium, ratings from prior jobs, proximity to job location, and etc. Alternatively, requests can also be sent out via an algorithm that assigns jobs on a first come first serve basis following batches of job dispatch requests (which may be sent out sequentially). In addition, the algorithm can also be configured to target available delivery medium within a smaller geofence radius to start with and change to a wider geofence radius as job dispatch requests are not being accepted (by the dispatching agents; in the case of a human dispatcher).

In the case that geo-location information is not available from the methods of resolution within the database 205 or external sources via APIs, the job processor 203b can execute either of the following: (1) use the nearest geo location information available in database to identify delivery medium; or (2) manually determine a delivery mechanism. In the manual determination process, instructions are generated and provided to personnel (of the system 109) to manually reach out to potential delivery medium in the areas of the available information. The delivery medium that accepts the job dispatch request can then follow the described process of receiving goods or instructions for the delivery process.

By way of example, when an order is placed for a flower arrangement to be delivered to a grave site, the system 109 utilizes the available geo-location coordinates to then query the available delivery personnel within a certain radius of the gravestone for the flower arrangement to be delivered to. The number of available delivery people (e.g., human dispatchers) within the geofence radius is noted. If the geo-location coordinates of the gravestone is not available, the cemetery of the grave stone can be used as the coordinate for determining the available delivery personnel.

The delivery processor functions to initiate the process of creating the tasks of sending goods or instructions to the delivery medium associated with the respective job. Once goods (or services) are delivered, the delivery medium will transmit, either based on geo-location information or based on nearest geo-location information, a notification about a need to determine the actual delivery location, as applicable.

Once delivered, the application interface (e.g., executed on UE 101n) provided to delivery medium will provide delivery confirmation with a geo-tagged image or video of the delivery. This image with its geo tag information is used to update and enrich the database to be used for future jobs.

In addition, the delivery medium (e.g., dispatcher) can also capture other images to enhance the database 205—e.g., by capturing images around the geo-location of interest. In the use of case of gravestones, images of other grave sites or landmarks can be captured. By way of example, when an order is placed for a flower arrangement to be delivered to a grave site, and the job for delivery has been assigned as well as accepted by a dispatcher, the system 109 can initiate the process of creating the shipping label to have the flower arrangement shipped to the delivery dispatcher. Under this scenario, the system 109 can track the shipment all the way through to when the flower arrangement is delivered to gravestone. A delivery confirmation is sent back to the consumer/requester either via a mobile application or web interface; as part of the confirmation capturing an image of the delivery and gravestone with an accurate geotag. In the case of not having a geo location coordinate of the gravestone, the delivery personnel can be provided with the physical address of the cemetery, and manually determine the specified gravestone. A successful delivery of the flower arrangement results in a new gravestone's geo location information for future use.

The database updater 203f is responsible for either correcting or enriching the database with either more accurate geo location data or new geo location data. As discussed, when a successful delivery of flower arrangement to a site (which the system 109 did not determine the geo-location coordinates), the delivery confirmation process in which an image is captured and geotag will trigger an update to the database with the appropriate name of deceased, cemetery location, picture of gravestone, and actual coordinates of the gravestone.

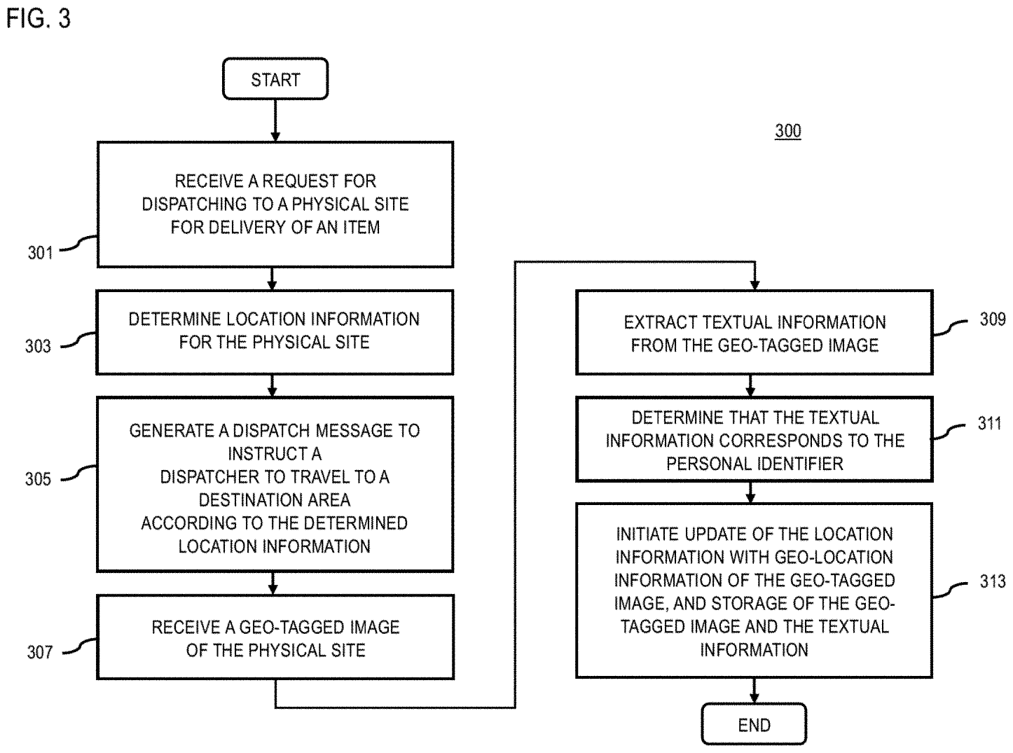

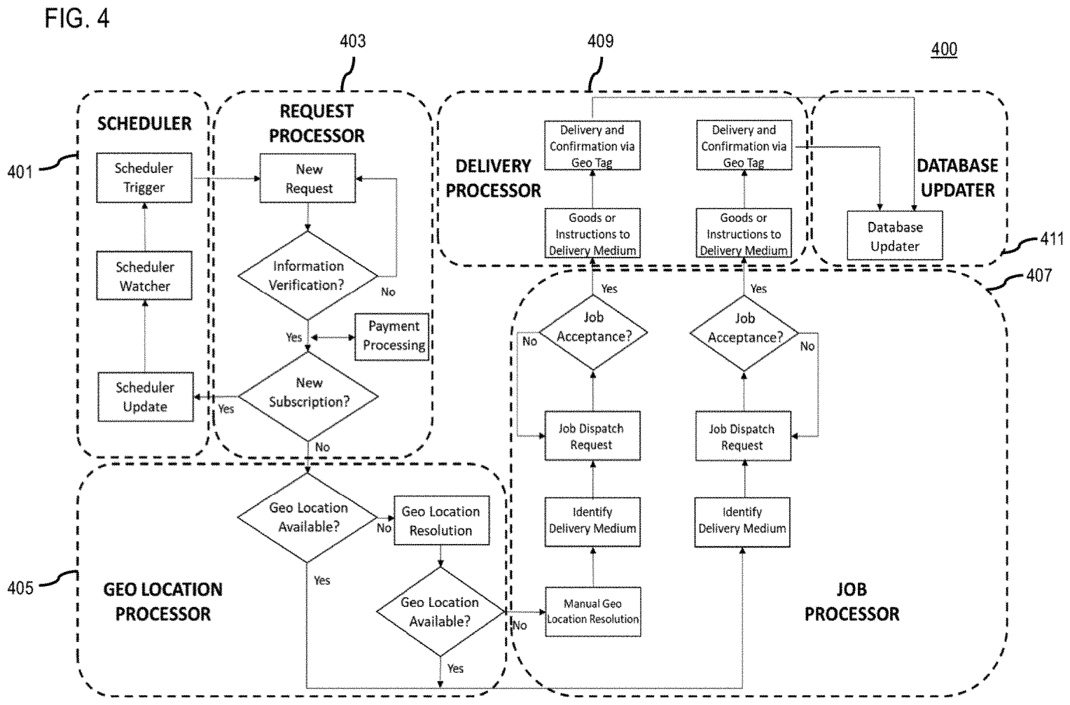

The above presented components 200 of the geo-location dispatch system 109 can be implemented in hardware, firmware, software, or a combination thereof. Though depicted as a separate entity in FIG. 1, it is contemplated that the geo-location dispatch system 109 may be implemented for direct operation by respective UE 101. As such, the geo-location dispatch system 109 may generate direct signal inputs by way of the operating system of the UE 101 for interacting with the applications 103. In another embodiment, one or more of the components/modules 200 of FIG. 2 and processes of FIGS. 3 and 4 may be implemented for operation by respective UEs, the geo-location dispatch system 109, or combination thereof. Still further, the geo-location dispatch system 109 may be integrated for direct operation with services 115, such as in the form of a widget or applet, in accordance with an information and/or subscriber sharing arrangement. The various executions presented herein contemplate any and all arrangements and models.

FIG. 3 is a flowchart of a process for dispatching to a geo-location, according to one embodiment. In one embodiment, the geo-location dispatch system 109 performs the process 300 and is implemented in, for instance, a chip set including a processor and a memory as shown in FIG. 11. In step 301, a request for dispatching to a physical site is received (e.g., by system 109 from UE 101a) for delivery of an item. The item can be any form of goods (e.g., flowers, balloons, gifts, etc.). According to one embodiment, the physical site includes a personal identifier (e.g., name, date of birth, date of death, etc.). Next, in step 303, the system 109 determines location information for the physical site; the location information includes address of a destination area that encompasses the physical site. In step 305, a dispatch message is generated to instruct a dispatcher (e.g., a person using UE 101n) to travel to a destination area according to the determined location information to deliver the item. In step 307, a geo-tagged image of the physical site is received as confirmation or verification of the physical site and the personal identifier. Per step 309, the system 109 extracts textual information from the geo-tagged image, and determines, per step 311, that the textual information corresponds to the personal identifier. Further, the system 109 initiates, per step 313, update of the location information with geo-location information of the geo-tagged image, and storage of the geo-tagged image and the textual information.

FIG. 4 is a diagram of the processes of the components of the geo-location dispatch system, according to various example embodiments. As depicted, the various components/modules 200 described in FIG. 2 interact according to the steps shown, according to one embodiment. The processes 400 correspond to certain functions/processes performed by the components 200, and include process 401 performed by the scheduler 203c, process 403 executed by the request processor 203a, process 405 performed by the geo location processor 203d, process 407 performed by the job processor 203b, process 409 executed by the delivery processor 203e, and process 411 executed by the database updater 203f.

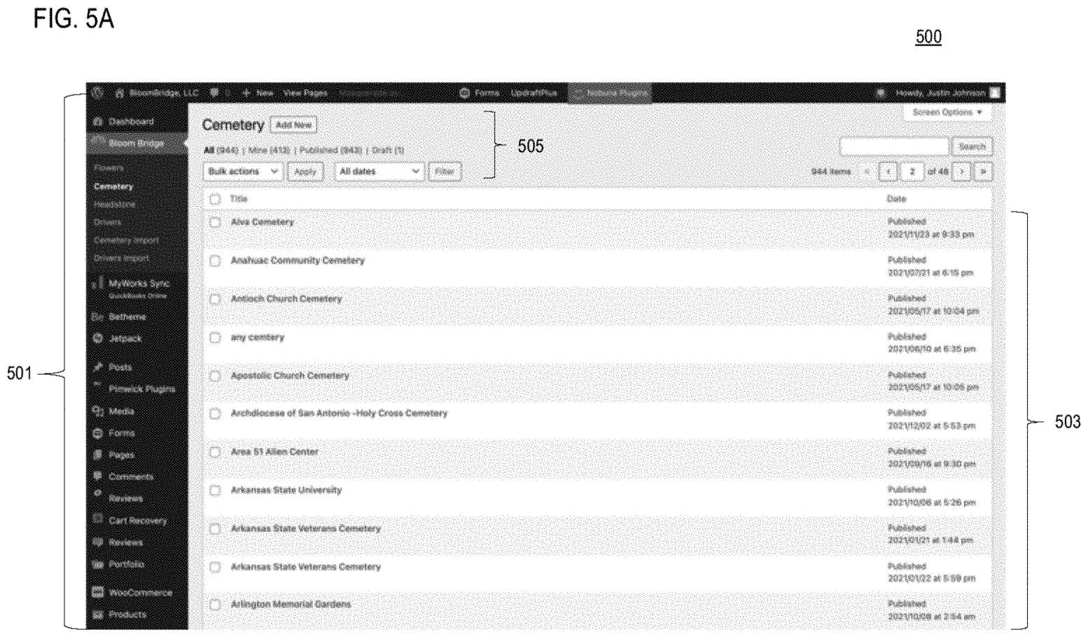

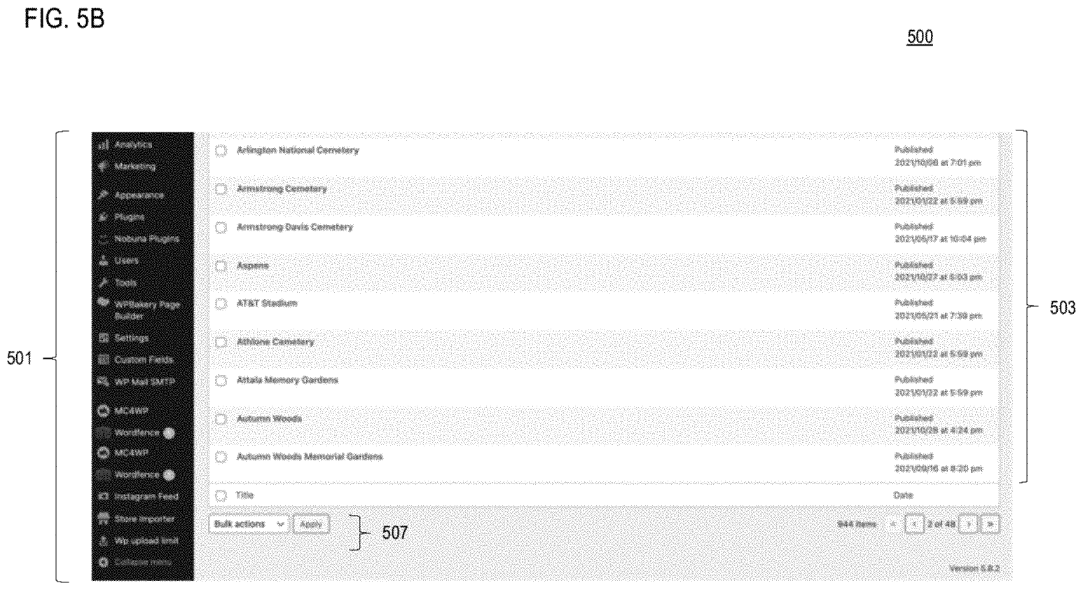

FIGS. 5A and 5B are diagrams of a graphical user interface (GUI) for specifying a cemetery for flower delivery to a grave site, according to various example embodiments. As shown, GUI 500 includes a section 501 that lists a variety of tabs/functions associated with ordering an item (e.g., flowers) for dispatch to a grave site (shown in FIG. 5A). Such tabs/functions include a “Cemetery” tab, which upon selection or activation enables input of one or more sites. These sites can be enumerated per section 503, whereby one or more cemeteries can be specified through simply clicking on the corresponding check box button. Additionally, an unlisted cemetery can be added via section 505; for example, an “Add New” button can be activated for a user to specify a new cemetery. Additionally, section 505 includes a pulldown menu of actions to be performed on selected cemeteries and a capability to filter down the list of cemeteries based on dates. As seen in FIG. 5B, section 507 again permits application of certain actions on any selected cemetery.

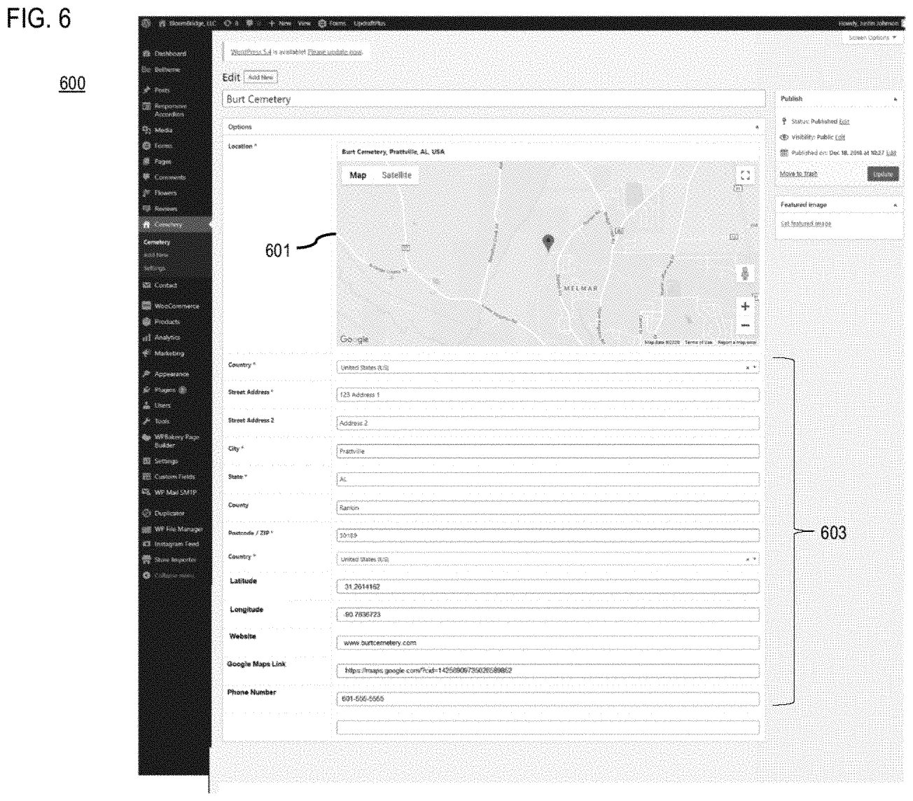

FIG. 6 is a diagram of a GUI providing a map of a cemetery, according to various example embodiments. As part of the “Cemetery” tab, GUI 600 provides a map 601 of the cemetery of interest. This map 601 assists with the verification of the correct selection of a cemetery. GUI 600 also includes text boxes 603 for inputting address information as well as other information (e.g., Uniform Resource Locator (URL), geo-location information (e.g., longitude and latitude), etc.).

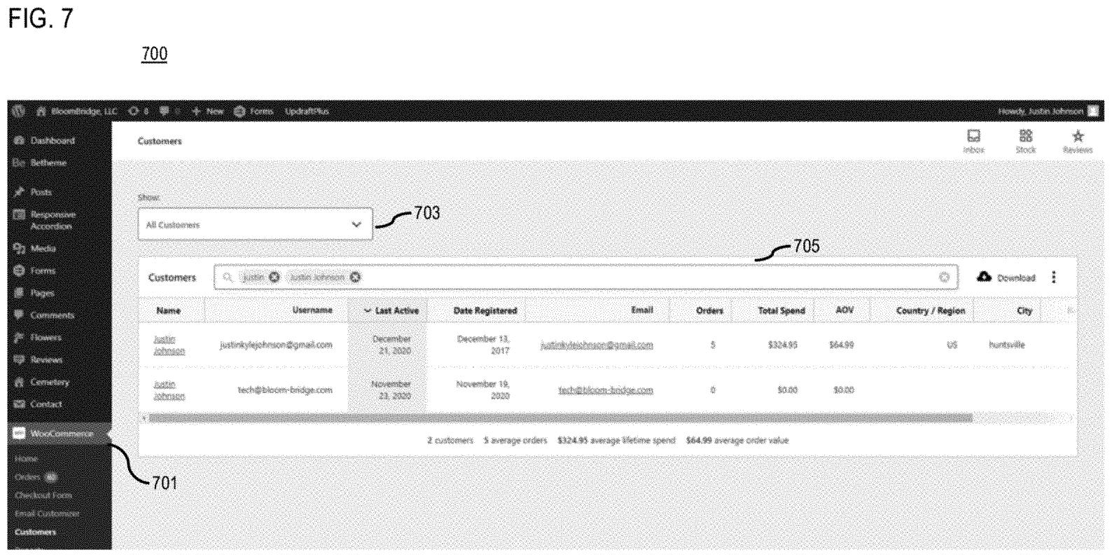

FIG. 7 is a diagram of a GUI associated with customer orders for delivery according to a geo-location within a cemetery, according to various example embodiments. In this example, GUI 700 provides a user with the capability to view all or a particular customer who has initiated a request to subscribe for item delivery. Customer and associated order information can be accessed through the selection of a “Commerce” tab 701, which upon activation provides section 703 and section 705. Within section 703, a pull-down menu can be triggered to show all or a particular customer. Under this scenario, “All Customers” is selected, and thus, section 705 displays customer information for all customers; section 705 also supports a search capability to filter the customers.

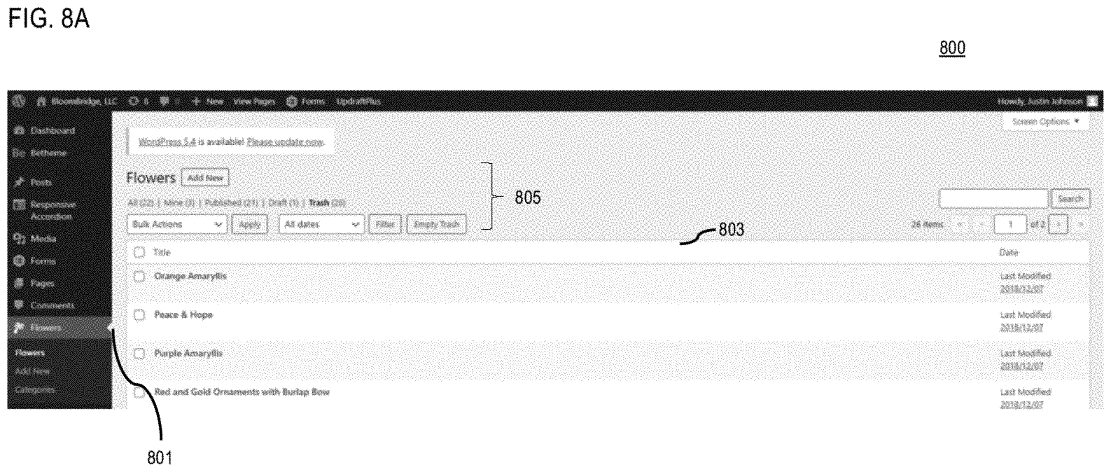

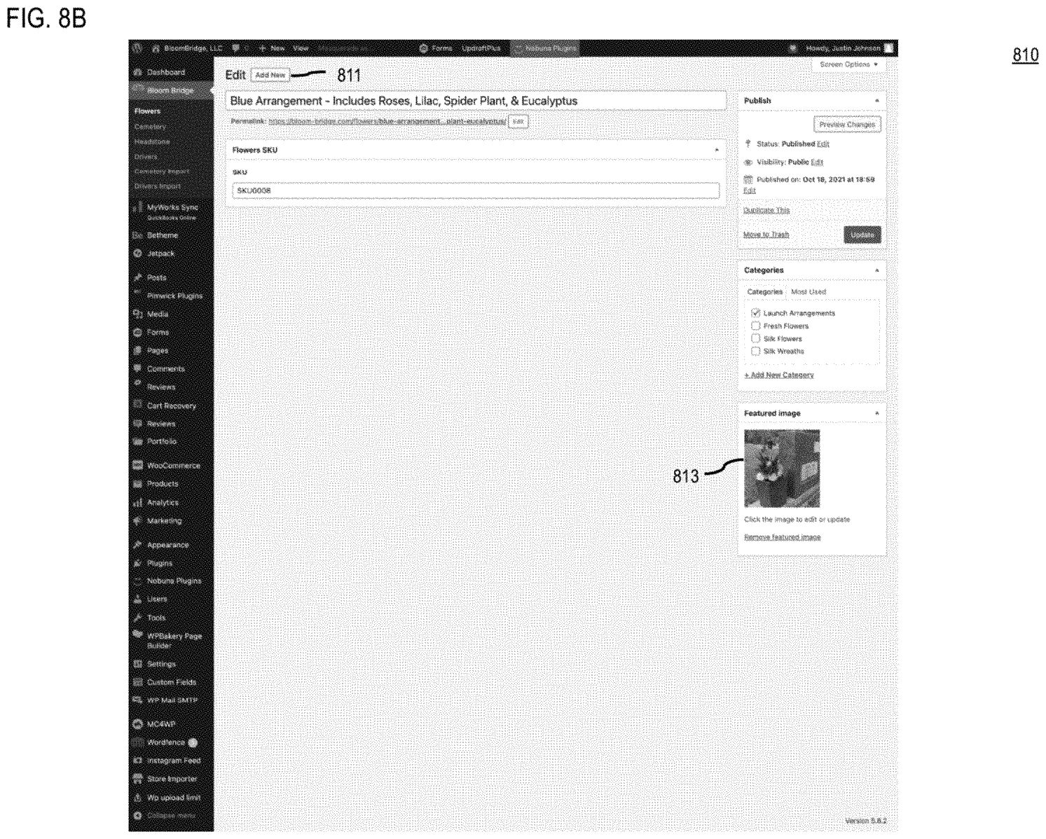

FIGS. 8A and 8B are diagrams of a GUI for selection of delivery items to a geo-location within a cemetery, according to various example embodiments. As noted, any particular item (e.g., balloons, stuffed animals, mementos, etc.) can be specified to be delivered to a grave site; however, for illustrative purposes, the items include flowers. Accordingly, GUI 800 provides a “Flowers” tab 801. Upon selection of tab 801, an enumeration of different types of flowers and/or flower arrangements are presented per section 803. Furthermore, new flowers and/or flower arrangements can be input via section 805. As shown in FIG. 8B, GUI 810 can be presented to enable editing of flowers and/or flower arrangements. For example, section 811 provides an “Add New” button to enable addition of a new flower and/or flower arrangement. GUI 810 also provides an image 813 of the flower and/or flower arrangement.

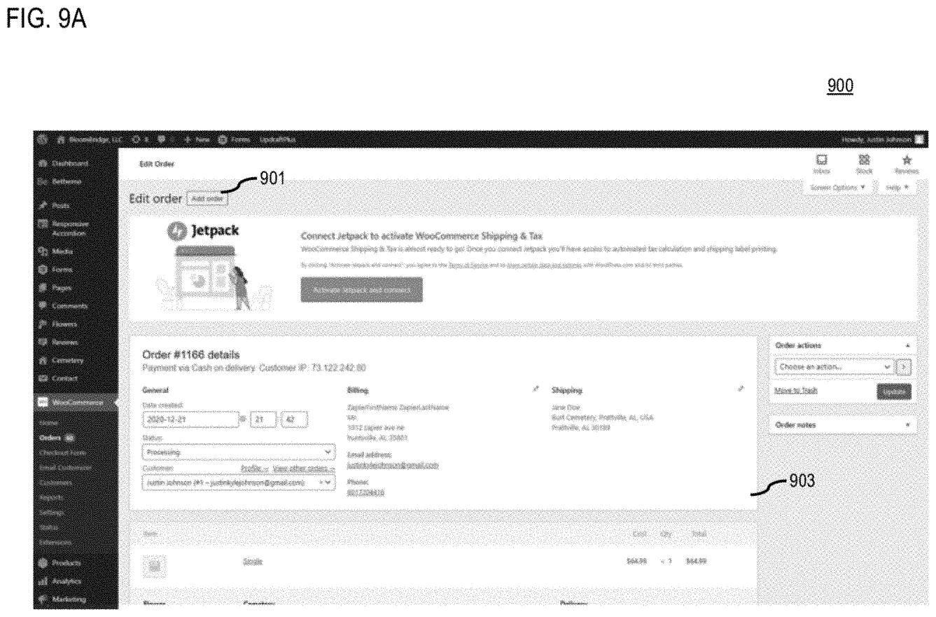

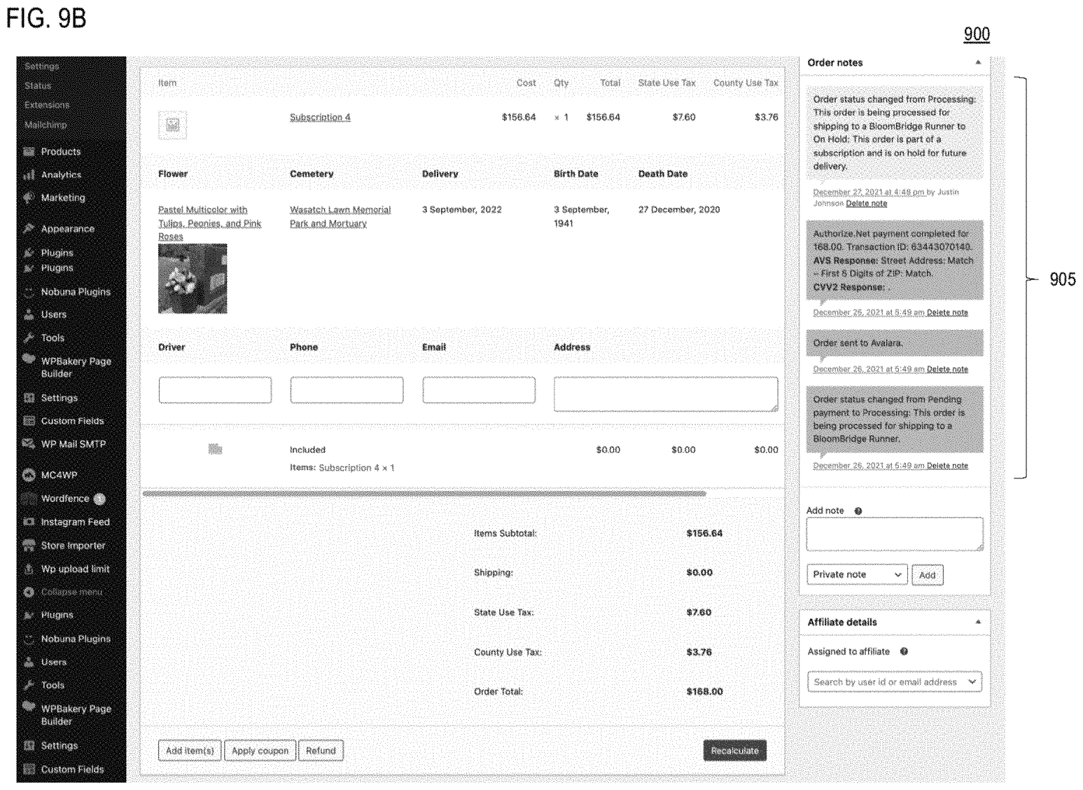

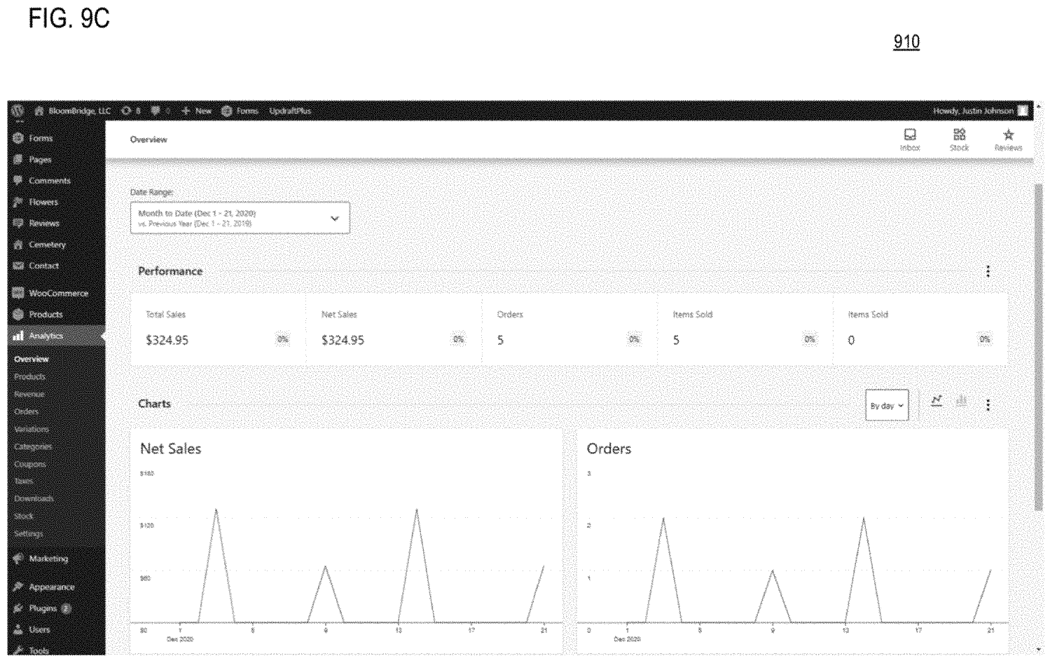

FIG. 9A-9C are diagrams of a GUI associated with customer orders, according to various example embodiments. Returning to the “Commerce” tab, FIG. 9A illustrates GUI 900, which enables the editing of an order. By way of example, section 901 permits the selection of a particular order, or all orders; it is contemplated that section 901 can provide more advanced search and filtering mechanisms to identify orders of interest. Section 903 displays order information including, but not limited to, order number, dates, status, billing information, delivery information, etc. Moreover, GUI 900 (shown in FIG. 9B) additionally presents other relevant information (via section 905) about the order, such as an image of the flower or flower arrangement, information about the dispatcher (e.g., driver name and phone number) as well as billing information.

Per FIG. 9C, GUI 910 provides, via an “Analytics” tab, on the order information as well as performance and sales information. In this manner, the profitability of the services provided by the geo-location dispatch system 109 can be precisely tracked. It is noted that other analytics can be monitored, e.g., frequency of deliveries to certain locations, distances traveled by the dispatchers, popularity of certain flowers/arrangements, repeat orders, average size of orders, etc.

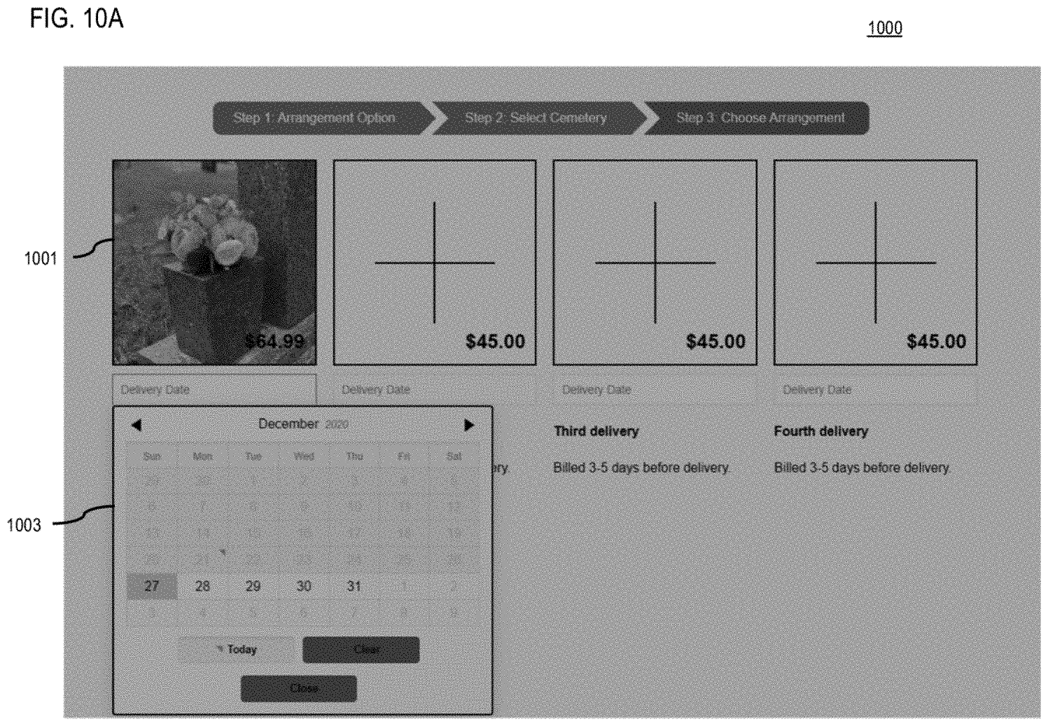

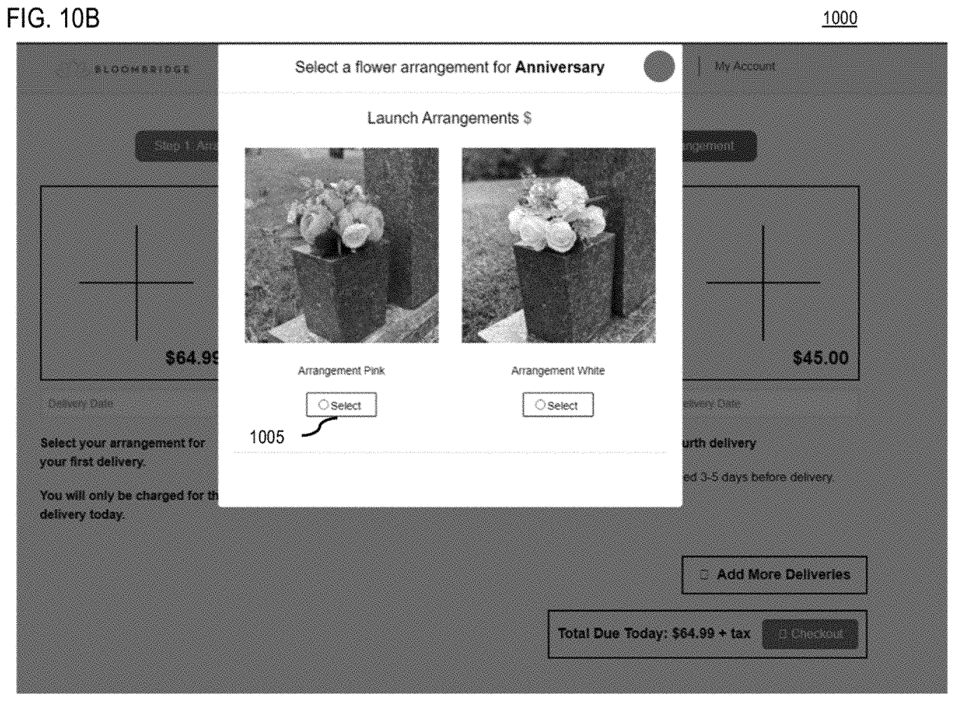

FIGS. 10A and 10B are diagrams of a GUI associated with scheduling and selection of delivery items, according to various example embodiments. As shown, GUI 1000 provides the capability to specify one or more delivery items with potentially different delivery dates. Consequently, a customer can elect to deliver different flowers to different sites based on a schedule. It is contemplated that the schedule can be set to allow for delivery on a recurring basis (e.g., every month, the first of each month or quarter, on recognized national occasions, etc.). Per the example, section 1001 presents an image of the flower or flower arrangement and corresponding schedule 1003.

FIGS. 11A-11C are diagrams of a GUI associated with a mobile application utilized by a dispatcher, according to various example embodiments. As seen in FIG. 11A, a dispatcher can receive a delivery request in which GUI 1101 provides a delivery date, along with information about the recipients. In this use case, there are two recipients: John Doe and his wife, Jane. In addition, GUI 1101 includes a description section that provides information about the wife; this information includes location information about her grave site as well as her birth date and death date. By way of example, the location information can be supplied via a URL (if the cemetery provides a website about the location of the graves), or an image of the grave site so that the dispatcher can readily identify the delivery point. Payment information is also supplied to the dispatcher. Based on all the supplied information, the dispatcher is given the option to decline or accept the task.

Upon acceptance of the delivery task, the dispatcher is presented with GUI 1103 (per FIG. 11B). GUI 1103 presents the address of the cemetery and order identification (ID) information. In FIG. 11C, GUI 1105 provides the capability for the dispatcher to capture an image of the delivery item at the deliver point; this image can then be relayed to the customer who requested the delivery service. In addition, GUI 1105 includes fields for the headstone (e.g., name and birth date, etc.) as a way to verify the correct recipient. Moreover, it is contemplated that the mobile application can collect such headstone information (if not available) to be maintained by the geo-location dispatch system 109.

The processes described herein for dispatching to a geo-location may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

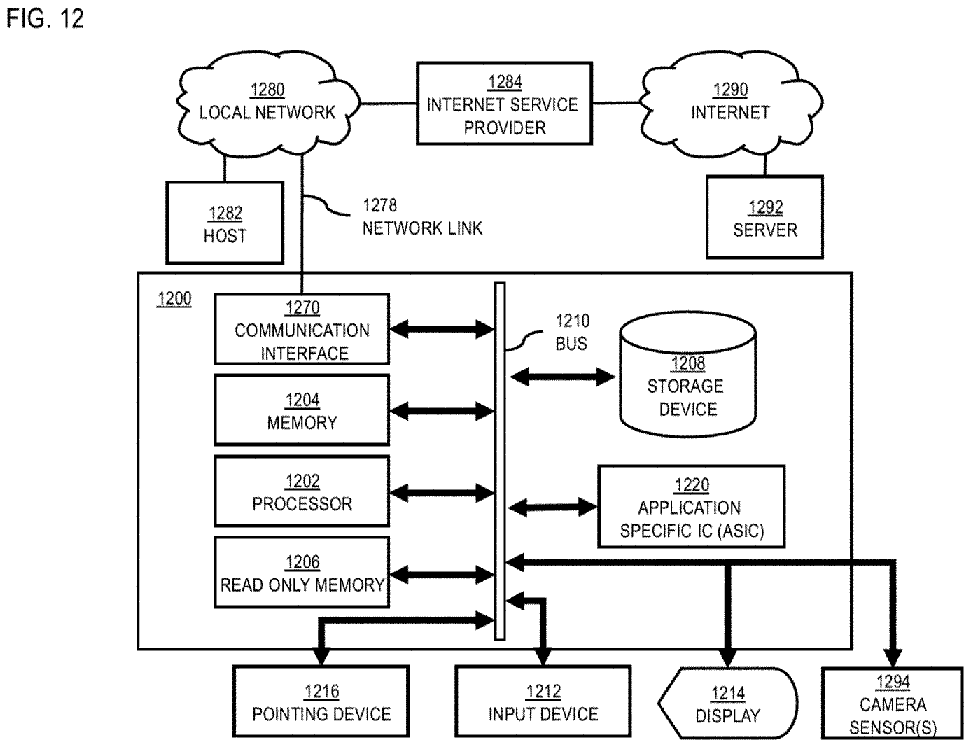

FIG. 12 illustrates a computer system 1200 upon which various embodiments of the invention may be implemented. Although computer system 1200 is depicted with respect to a particular device or equipment, it is contemplated that other devices or equipment (e.g., network elements, servers, etc.) within FIG. 12 can deploy the illustrated hardware and components of system 1200. Computer system 1200 is programmed (e.g., via computer program code or instructions) to dispatch in support of services or delivery of goods as described herein and includes a communication mechanism such as a bus 1210 for passing information between other internal and external components of the computer system 1200. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1200, or a portion thereof, constitutes a means for performing one or more steps of the processes described herein, including those of FIGS. 3 and 4.

A bus 1210 includes one or more parallel conductors of information so that information is transferred quickly among devices coupled to the bus 1210. One or more processors 1202 for processing information are coupled with the bus 1210.

A processor (or multiple processors) 1202 performs a set of operations on information as specified by computer program code related to dispatching to a geo-location. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1210 and placing information on the bus 1210. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1202, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1200 also includes a memory 1204 coupled to bus 1210. The memory 1204, such as a random access memory (RANI) or any other dynamic storage device, stores information including processor instructions for dispatching of delivery items to a geo-location based, at least in part, on analysis of sensor information. Dynamic memory allows information stored therein to be changed by the computer system 1200. RAM allows a unit of information stored at a location called a memory address to be stored and retrieved independently of information at neighboring addresses. The memory 1204 is also used by the processor 1202 to store temporary values during execution of processor instructions. The computer system 1200 also includes a read only memory (ROM) 1206 or any other static storage device coupled to the bus 1210 for storing static information, including instructions, that is not changed by the computer system 1200. Some memory is composed of volatile storage that loses the information stored thereon when power is lost. Also coupled to bus 1210 is a non-volatile (persistent) storage device 1208, such as a magnetic disk, optical disk or flash card, for storing information, including instructions, that persists even when the computer system 1200 is turned off or otherwise loses power.

Information, including instructions for dispatching of delivery items to a geo-location based, at least in part, on analysis of sensor information, is provided to the bus 1210 for use by the processor from an external input device 1212, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1200. Other external devices coupled to bus 1210, used primarily for interacting with humans, include a display device 1214, such as a vacuum fluorescent display (VFD), a liquid crystal display (LCD), a light-emitting diode (LED), an organic light-emitting diode (OLED), a quantum dot display, a virtual reality (VR) headset, a plasma screen, a cathode ray tube (CRT), or a printer for presenting text or images, and a pointing device 1216, such as a mouse, a trackball, cursor direction keys, or a motion sensor, for controlling a position of a small cursor image presented on the display 1214 and issuing commands associated with graphical elements presented on the display 1214, and one or more camera sensors 1294 for capturing, recording and causing to store one or more still and/or moving images (e.g., videos, movies, etc.) which also may comprise audio recordings. In some embodiments, for example, in embodiments in which the computer system 1200 performs all functions automatically without human input, one or more of external input device 1212, a display device 1214 and pointing device 1216 may be omitted.

In the illustrated embodiment, special purpose hardware, such as an application specific integrated circuit (ASIC) 1220, is coupled to bus 1210. The special purpose hardware is configured to perform operations not performed by processor 1202 quickly enough for special purposes. Examples of ASICs include graphics accelerator cards for generating images for display 1214, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1200 also includes one or more instances of a communications interface 1270 coupled to bus 1210. Communication interface 1270 provides a one-way or two-way communication coupling to a variety of external devices that operate with their own processors, such as printers, scanners, and external disks. In general, the coupling is with a network link 1278 that is connected to a local network 1280 to which a variety of external devices with their own processors are connected. For example, communication interface 1270 may be a parallel port or a serial port or a universal serial bus (USB) port on a personal computer. In some embodiments, communications interface 1270 is an integrated services digital network (ISDN) card or a digital subscriber line (DSL) card or a telephone modem that provides an information communication connection to a corresponding type of telephone line. In some embodiments, a communication interface 1270 is a cable modem that converts signals on bus 1210 into signals for a communication connection over a coaxial cable or into optical signals for a communication connection over a fiber optic cable. As another example, communications interface 1270 may be a local area network (LAN) card to provide a data communication connection to a compatible LAN, such as Ethernet. Wireless links may also be implemented. For wireless links, the communications interface 1270 sends or receives or both sends and receives electrical, acoustic or electromagnetic signals, including infrared and optical signals, that carry information streams, such as digital data. For example, in wireless handheld devices, such as mobile telephones like cell phones, the communications interface 1270 includes a radio band electromagnetic transmitter and receiver called a radio transceiver. In certain embodiments, the communications interface 1270 enables connection to the communication network 127 for providing geo-location dispatching based, at least in part, on analysis of sensor information to the UE 121.

The term “computer-readable medium” as used herein refers to any medium that participates in providing information to processor 1202, including instructions for execution. Such a medium may take many forms, including, but not limited to a computer-readable storage medium (e.g., non-volatile media, volatile media), and transmission media. Non-transitory media, such as non-volatile media, include, for example, optical or magnetic disks, such as storage device 1208. Volatile media include, for example, dynamic memory 1204. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1220.

Network link 1278 typically provides information communication using transmission media through one or more networks to other devices that use or process the information. For example, network link 1278 may provide a connection through local network 1280 to a host computer 1282 or to equipment 1284 operated by an Internet Service Provider (ISP). ISP equipment 1284 in turn provides data communication services through the public, world-wide packet-switching communication network of networks now commonly referred to as the Internet 1290.

A computer called a server host 1292 connected to the Internet hosts a process that provides a service in response to information received over the Internet. For example, server host 1292 hosts a process that provides information representing video data for presentation at display 1214. It is contemplated that the components of system 1200 can be deployed in various configurations within other computer systems, e.g., host 1282 and server 1292.

At least some embodiments of the invention are related to the use of computer system 1200 for implementing some or all of the techniques described herein. According to one embodiment of the invention, those techniques are performed by computer system 1200 in response to processor 1202 executing one or more sequences of one or more processor instructions contained in memory 1204. Such instructions, also called computer instructions, software and program code, may be read into memory 1204 from another computer-readable medium such as storage device 1208 or network link 1278. Execution of the sequences of instructions contained in memory 1204 causes processor 1202 to perform one or more of the method steps described herein. In alternative embodiments, hardware, such as ASIC 1220, may be used in place of or in combination with software to implement the invention. Thus, embodiments of the invention are not limited to any specific combination of hardware and software, unless otherwise explicitly stated herein.

The signals transmitted over network link 1278 and other networks through communications interface 1270, carry information to and from computer system 1200. Computer system 1200 can send and receive information, including program code, through the networks 1280, 1290 among others, through network link 1278 and communications interface 1270. In an example using the Internet 1290, a server host 1292 transmits program code for a particular application, requested by a message sent from computer 1200, through Internet 1290, ISP equipment 1284, local network 1280 and communications interface 1270. The received code may be executed by processor 1202 as it is received, or may be stored in memory 1204 or in storage device 1208 or any other non-volatile storage for later execution, or both. In this manner, computer system 1200 may obtain application program code in the form of signals on a carrier wave.

Various forms of computer readable media may be involved in carrying one or more sequence of instructions or data or both to processor 1202 for execution. For example, instructions and data may initially be carried on a magnetic disk of a remote computer such as host 1282. The remote computer loads the instructions and data into its dynamic memory and sends the instructions and data over a telephone line using a modem. A modem local to the computer system 1200 receives the instructions and data on a telephone line and uses an infra-red transmitter to convert the instructions and data to a signal on an infra-red carrier wave serving as the network link 1278. An infrared detector serving as communications interface 1270 receives the instructions and data carried in the infrared signal and places information representing the instructions and data onto bus 1210. Bus 1210 carries the information to memory 1204 from which processor 1202 retrieves and executes the instructions using some of the data sent with the instructions. The instructions and data received in memory 1204 may optionally be stored on storage device 1208, either before or after execution by the processor 1202.

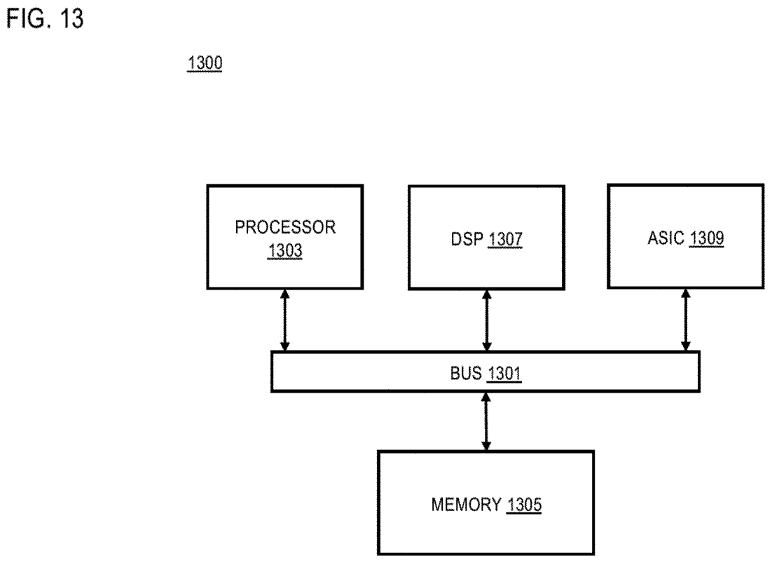

FIG. 13 illustrates a chip set or chip 1300 upon which various embodiments of the invention may be implemented. Chip set 1300 is programmed to dispatch delivery items to a geo-location based, at least in part, on analysis of sensor information as described herein and includes, for instance, the processor and memory components described with respect to FIG. 12 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1300 can be implemented in a single chip. It is further contemplated that in certain embodiments the chip set or chip 1300 can be implemented as a single “system on a chip.” It is further contemplated that in certain embodiments a separate ASIC would not be used, for example, and that all relevant functions as disclosed herein would be performed by a processor or processors. Chip set or chip 1300, or a portion thereof, constitutes a means for performing one or more steps of providing user interface navigation information associated with the availability of functions. Chip set or chip 1300, or a portion thereof, constitutes a means for performing one or more steps of dispatching to a geo-location.

In one embodiment, the chip set or chip 1300 includes a communication mechanism such as a bus 1301 for passing information among the components of the chip set 1300. A processor 1303 has connectivity to the bus 1301 to execute instructions and process information stored in, for example, a memory 1305. The processor 1303 may include one or more processing cores with each core configured to perform independently. A multi-core processor enables multiprocessing within a single physical package. Examples of a multi-core processor include two, four, eight, or greater numbers of processing cores. Alternatively or in addition, the processor 1303 may include one or more microprocessors configured in tandem via the bus 1301 to enable independent execution of instructions, pipelining, and multithreading. The processor 1303 may also be accompanied with one or more specialized components to perform certain processing functions and tasks such as one or more digital signal processors (DSP) 1307, or one or more application-specific integrated circuits (ASIC) 1309. A DSP 1307 typically is configured to process real-world signals (e.g., sound) in real time independently of the processor 1303. Similarly, an ASIC 1309 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1300 includes merely one or more processors and some software and/or firmware supporting and/or relating to and/or for the one or more processors.

The processor 1303 and accompanying components have connectivity to the memory 1305 via the bus 1301. The memory 1305 includes both dynamic memory (e.g., RAM, magnetic disk, writable optical disk, etc.) and static memory (e.g., ROM, CD-ROM, etc.) for storing executable instructions that when executed perform the inventive steps described herein to provide dispatching to a geo-location. The memory 1305 also stores the data associated with or generated by the execution of the inventive steps.

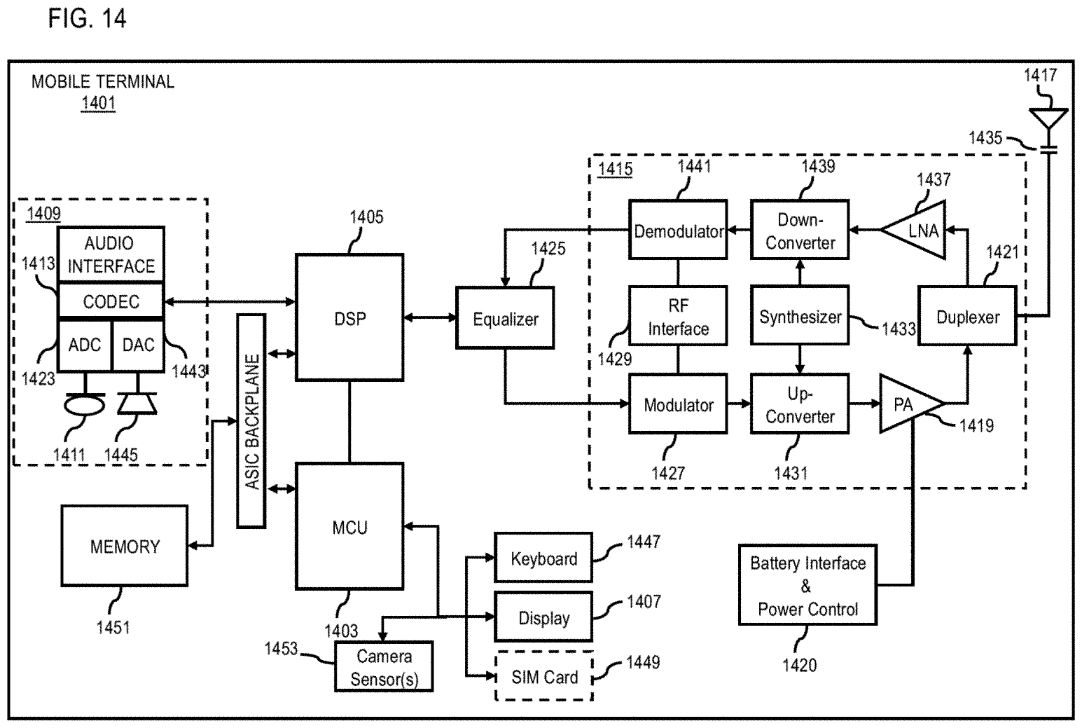

FIG. 14 is a diagram of exemplary components of a mobile terminal (e.g., handset) for communications, which is capable of operating in the system of FIG. 1, according to one embodiment. In some embodiments, mobile terminal 1401, or a portion thereof, constitutes a means for performing one or more steps of dispatching to a geo-location. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1403, a Digital Signal Processor (DSP) 1405, and a receiver/transmitter unit including a microphone gain control unit and a speaker gain control unit. A main display unit 1407 provides a display to the user in support of various applications and mobile terminal functions that perform or support the steps of dispatching to a geo-location. The display 1407 includes display circuitry configured to display at least a portion of a user interface of the mobile terminal (e.g., mobile telephone). Additionally, the display 1407 and display circuitry are configured to facilitate user control of at least some functions of the mobile terminal. An audio function circuitry 1409 includes a microphone 1411 and microphone amplifier that amplifies the speech signal output from the microphone 1411. The amplified speech signal output from the microphone 1411 is fed to a coder/decoder (CODEC) 1413.

A radio section 1415 amplifies the power and converts frequency in order to communicate with a base station, which is included in a mobile communication system, via antenna 1417. The power amplifier (PA) 1419 and the transmitter/modulation circuitry are operationally responsive to the MCU 1403, with an output from the PA 1419 coupled to the duplexer 1421 or circulator or antenna switch, as known in the art. The PA 1419 also couples to a battery interface and power control unit 1420.

In use, a user of mobile terminal 1401 speaks into the microphone 1411 and his or her voice along with any detected background noise is converted into an analog voltage. The analog voltage is then converted into a digital signal through the Analog to Digital Converter (ADC) 1423. The control unit 1403 routes the digital signal into the DSP 1405 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1425 for compensation of any frequency-dependent impairments that occur during transmission though the air such as phase and amplitude distortion. After equalizing the bit stream, the modulator 1427 combines the signal with an RF signal generated in the RF interface 1429. The modulator 1427 generates a sine wave by way of frequency or phase modulation. In order to prepare the signal for transmission, an up-converter 1431 combines the sine wave output from the modulator 1427 with another sine wave generated by a synthesizer 1433 to achieve the desired frequency of transmission. The signal is then sent through a PA 1419 to increase the signal to an appropriate power level. In practical systems, the PA 1419 acts as a variable gain amplifier whose gain is controlled by the DSP 1405 from information received from a network base station. The signal is then filtered within the duplexer 1421 and optionally sent to an antenna coupler 1435 to match impedances to provide maximum power transfer. Finally, the signal is transmitted via antenna 1417 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1401 are received via antenna 1417 and immediately amplified by a low noise amplifier (LNA) 1437. A down-converter 1439 lowers the carrier frequency while the demodulator 1441 strips away the RF leaving only a digital bit stream. The signal then goes through the equalizer 1425 and is processed by the DSP 1405. A Digital to Analog Converter (DAC) 1443 converts the signal and the resulting output is transmitted to the user through the speaker 1445, all under control of a Main Control Unit (MCU) 1403 which can be implemented as a Central Processing Unit (CPU).

The MCU 1403 receives various signals including input signals from the keyboard 1447. The keyboard 1447 and/or the MCU 1403 in combination with other user input components (e.g., the microphone 1411) comprise a user interface circuitry for managing user input. The MCU 1403 runs a user interface software to facilitate user control of at least some functions of the mobile terminal 1401 to provide dispatching to a geo-location. The MCU 1403 also delivers a display command and a switch command to the display 1407 and to the speech output switching controller, respectively. Further, the MCU 1403 exchanges information with the DSP 1405 and can access an optionally incorporated SIM card 1449 and a memory 1451. In addition, the MCU 1403 executes various control functions required of the terminal. The DSP 1405 may, depending upon the implementation, perform any of a variety of conventional digital processing functions on the voice signals. Additionally, DSP 1405 determines the background noise level of the local environment from the signals detected by microphone 1411 and sets the gain of microphone 1411 to a level selected to compensate for the natural tendency of the user of the mobile terminal 1401.

The CODEC 1413 includes the ADC 1423 and DAC 1443. The memory 1451 stores various data including call incoming tone data and is capable of storing other data including music data received via, e.g., the global Internet. The software module could reside in RAM memory, flash memory, registers, or any other form of writable storage medium known in the art. The memory device 1451 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1449 carries, for instance, important information, such as the cellular phone number, the carrier supplying service, subscription details, and security information. The SIM card 1449 serves primarily to identify the mobile terminal 1401 on a radio network. The card 1449 also contains a memory for storing a personal telephone number registry, text messages, and user specific mobile terminal settings.

Further, one or more camera sensors 1453 may be incorporated onto the mobile station 1401 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a request for dispatching to a physical site for delivery of an item, wherein the physical site includes a personal identifier;
determining location information for the physical site, wherein the location information includes address of a destination area that encompasses the physical site;
generating a dispatch message to instruct a dispatcher to travel to the destination area according to the determined location information to deliver the item;
receiving a geo-tagged image of the physical site as verification of the physical site and the personal identifier;
extracting textual information from the geo-tagged image;
determining that the textual information corresponds to the personal identifier; and
initiating update of the location information with geo-location information of the geo-tagged image, and storage of the geo-tagged image and the textual information.

2. The method of claim 1, further comprising:
generating an order, in response to the request, for the delivery of the item;
selecting the item as part of the generating of the order; and
receiving input relating to timing information for the delivery of the item to the physical site.

3. The method of claim 2, wherein the destination area specifies a cemetery, and the physical site includes a grave site.

4. The method of claim 3, wherein the personal identifier includes information relating to a name, birthdate information, and date of death information associated with the grave site, and wherein the timing information specifies periodic delivery of the item to the grave site.

5. The method of claim 2, further comprising:
establishing a customer profile associated with the order, wherein the customer profile specifies preference information for a plurality of items including the item.

6. The method of claim 1, further comprising:
generating a graphical user interface to present a plurality of destination areas designated to receive the delivery of the item, wherein the graphical user interface displays a map of the destination area and an image of the item.

7. The method of claim 1, wherein the geo-tagged image is captured via a mobile device.

8. A system comprising:
a memory configured to store computer-executable instructions; and
one or more processors configured to execute the instructions to:
receive a request for dispatching to a physical site for delivery of an item, wherein the physical site includes a personal identifier;
determine location information for the physical site, wherein the location information includes address of a destination area that encompasses the physical site;
generate a dispatch message to instruct a dispatcher to travel to the destination area according to the determined location information to deliver the item;
receive a geo-tagged image of the physical site as verification of the physical site and the personal identifier;
extract textual information from the geo-tagged image;
determine that the textual information corresponds to the personal identifier; and
initiate update of the location information with geo-location information of the geo-tagged image, and storage of the geo-tagged image and the textual information.

9. The system of claim 8, wherein the one or more processors are further configured to execute the instructions to:
generate an order, in response to the request, for the delivery of the item;
select the item as part of the generating of the order; and
receive input relating to timing information for the delivery of the item to the physical site.

10. The system of claim 9, wherein the destination area specifies a cemetery, and the physical site includes a grave site.

11. The system of claim 10, wherein the personal identifier includes information relating to a name, birthdate information, and date of death information associated with the grave site, and wherein the timing information specifies periodic delivery of the item to the grave site.

12. The system of claim 9, wherein the one or more processors are further configured to execute the instructions to:
establish a customer profile associated with the order, wherein the customer profile specifies preference information for a plurality of items including the item.

13. The system of claim 8, wherein the one or more processors are further configured to execute the instructions to:
generate a graphical user interface to present a plurality of destination areas designated to receive the delivery of the item, wherein the graphical user interface displays a map of the destination area and an image of the item.

14. The system of claim 8, wherein the geo-tagged image is captured via a mobile device.

15. An apparatus comprising:
at least one processor; and
at least one memory including computer program code for one or more programs,
the at least one memory and the computer program code configured to, with the at least one processor, cause the apparatus to perform at least the following,
receive a request for dispatching to a physical site for delivery of an item, wherein the physical site includes a personal identifier;
determine location information for the physical site, wherein the location information includes address of a destination area that encompasses the physical site;
generate a dispatch message to instruct a dispatcher to travel to the destination area according to the determined location information to deliver the item;
receive a geo-tagged image of the physical site as verification of the physical site and the personal identifier;
extract textual information from the geo-tagged image;
determine that the textual information corresponds to the personal identifier; and
initiate update of the location information with geo-location information of the geo-tagged image, and storage of the geo-tagged image and the textual information.

16. The apparatus of claim 15, wherein the apparatus is further caused to:
generate an order, in response to the request, for the delivery of the item;
select the item as part of the generating of the order; and
receive input relating to timing information for the delivery of the item to the physical site.

17. The apparatus of claim 16, wherein the destination area specifies a cemetery, and the physical site includes a grave site.

18. The apparatus of claim 17, wherein the personal identifier includes information relating to a name, birthdate information, and date of death information associated with the grave site, and wherein the timing information specifies periodic delivery of the item to the grave site.

19. The apparatus of claim 16, wherein the apparatus is further caused to:
establish a customer profile associated with the order, wherein the customer profile specifies preference information for a plurality of items including the item.

20. The apparatus of claim 15, wherein the geo-tagged image is captured via a mobile device, and wherein the apparatus is further caused to:
generate a graphical user interface to present a plurality of destination areas designated to receive the delivery of the item, wherein the graphical user interface displays a map of the destination area and an image of the item.
